(19) United States
(12) Patent Application Publication
(10) Pub. No.: US 2019/0026374 A1
(43) Pub. Date: Jan. 24, 2019

(54) SEARCH METHOD AND APPARATUS

(71) Applicant: Alibaba Group Holding Limited, Grand Cayman (KY)

(72) Inventors: Shichen Liu, Hangzhou (CN); Dan Ou, Hangzhou (CN); Wenwu Ou, Hangzhou (CN)

(73) Assignee: Alibaba Group Holding Limited

(21) Appl. No.: 16/039,152

(22) Filed: Jul. 18, 2018

(30) Foreign Application Priority Data
Jul. 19, 2017 (CN) 201710591943.X

(51) Int. Cl. G06F 17/30; G06F 17/10; G06K 9/62

(52) U.S. Cl. CPC G06F 17/30867; G06K 9/6215; G06F 17/10; G06F 17/30651

(57) ABSTRACT

After multiple objects related to a keyword are found, presentation values of the objects are calculated by combining multiple similarity measures between the objects and a historical behavior object of a user, and the objects are presented according to the presentation values of the objects. The similarity measures use the historical behavior object of the user as a reference, and the presentation values consider similarity degrees between to-be-presented objects and the historical behavior object of the user from multiple perspectives; therefore, a search result is coincident with the behavior habit of the user.

### CROSS REFERENCE TO RELATED PATENT APPLICATIONS

This application claims priority to Chinese Patent Application No. 201710591943.X, filed on Jul. 19, 2017 and entitled “SEARCH METHOD AND APPARATUS”, which is incorporated herein by reference in its entirety.

### TECHNICAL FIELD

The present disclosure relates to the field of electronic information, and, more particularly, to search methods and apparatuses.

### BACKGROUND

A search engine is a common function of a website. After a user enters a keyword in a search engine, the search engine searches according to the keyword to find related search results, and sorts the search results for displaying. For example, after receiving a keyword entered by a user, a search engine of an e-commerce website finds item information related to the keyword, sorts the item information, and presents the item information to the user according to the sorting result.

However, existing search methods output search results only according to a keyword and do not consider other factors, thereby failing to obtain a more accurate search result for the user.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

The present disclosure provides search methods and apparatuses to solve the problem of how to obtain an accurate search result for a user.

The present disclosure provides the following technical solutions:

A search method, including:

acquiring multiple objects related to a search keyword of a user;

calculating similarity measures between the multiple objects and a historical behavior object of the user, wherein the similarity measures at least include inter-object similarity measures, the inter-object similarity measures are determined at least based on basic behavior similarity measures between the multiple objects and the historical behavior object, and the basic behavior similarity measures between the multiple objects and the historical behavior object indicate that the user making a historical behavior for the historical behavior object makes similar behaviors for the multiple objects within a period of time;

calculating, by combining similarity measures of a respective object among the multiple objects, a presentation value of the respective object; and

presenting the multiple objects according to presentation values of the multiple objects.

Optionally, the similarity measures further include:

source similarity measures of objects and/or type similarity measures of objects,

wherein the source similarity measures of the multiple objects are used for indicating similarity degrees between sources of the multiple objects and a source of the historical behavior object; and

the type similarity measures of the multiple objects are used for indicating similarity degrees between types of the multiple objects and a type of the historical behavior object.

Optionally, the inter-object similarity measures are further determined based on general similarity measures between the multiple objects and the historical behavior object, wherein the general similarity measures between the multiple objects and the historical behavior object include image similarity degrees between the multiple objects and the historical behavior object and/or differences between attributes of the multiple objects and the historical behavior object.

Optionally, the process of determining an inter-object similarity measure between the respective object among the multiple objects and the historical behavior object includes:

calculating an inter-object similarity measure between the respective object and any historical behavior object of the user; and

multiplying the inter-object similarity measure by a weight value of the historical behavior of the user to obtain the inter-object similarity measure between the respective object and the historical behavior object.

A search method, including:

acquiring multiple objects related to a search keyword of a user;

acquiring a historical behavior object of the user; and

determining a presentation order of the multiple objects based on similarity measures between the multiple objects and the historical behavior object of the user,

wherein the similarity measures are determined based on basic behavior similarity measures between the multiple objects and the historical behavior object, and the basic behavior similarity measures between the multiple objects and the historical behavior object indicate that the user making a historical behavior for the historical behavior object makes similar behaviors for the multiple objects within a period of time.

Optionally, the process of determining a similarity measure between a respective object among the multiple objects and the historical behavior object includes:

calculating a basic behavior similarity measure between the respective object and any historical behavior object of the user; and

multiplying the basic behavior similarity measure by a weight value of the historical behavior of the user to obtain the inter-object similarity measure between the respective object and the historical behavior object.

A search apparatus, including:

an acquisition module configured to acquire multiple objects related to a search keyword of a user;

a first calculation module configured to calculate similarity measures between the multiple objects and a historical behavior object of the user, wherein the similarity measures at least include inter-object similarity measures, the inter-object similarity measures are determined at least based on basic behavior similarity measures between the multiple objects and the historical behavior object, and the basic behavior similarity measures between the multiple objects and the historical behavior object indicate that the user making a historical behavior for the historical behavior object makes similar behaviors for the multiple objects within a period of time;

a second calculation module configured to calculate, by combining similarity measures of a respective object among the multiple objects, a presentation value of the respective object; and

a presentation module configured to present the multiple objects according to presentation values of the multiple objects.

Optionally, the first calculation module is configured to:

calculate source similarity measures between the respective objects and the historical behavior object of the user and/or type similarity measures of objects, wherein the source similarity measures of the multiple objects are used for indicating similarity degrees between sources of the multiple objects and a source of the historical behavior object; and the type similarity measures of the multiple objects are used for indicating similarity degrees between types of the multiple objects and a type of the historical behavior object.

Optionally, the first calculation module is configured to:

further determine the inter-object similarity measures based on general similarity measures between the multiple objects and the historical behavior object, wherein the general similarity measures between the multiple objects and the historical behavior object include image similarity degrees between the multiple objects and the historical behavior object and/or differences between attributes of the multiple objects and the historical behavior object.

Optionally, the first calculation module is configured to:

calculate an inter-object similarity measure between the respective object and any historical behavior object of the user; and multiply the inter-object similarity measure by a weight value of the historical behavior of the user to obtain the inter-object similarity measure between the object and the historical behavior object.

A computer readable storage medium is provided, where computer-readable instructions are stored in the computer readable storage medium, and the computer-readable instructions enable a computing device including one or more processors to execute the following functions when run on the computing device: acquiring multiple objects related to a search keyword of a user; calculating similarity measures between the multiple objects and a historical behavior object of the user, where the similarity measures at least include inter-object similarity measures, the inter-object similarity measures are determined at least based on basic behavior similarity measures between the multiple objects and the historical behavior object, and the basic behavior similarity measures between the multiple objects and the historical behavior object indicate that the user making a historical behavior for the historical behavior object makes similar behaviors for the multiple objects within a period of time; calculating, by combining similarity measures of any object among the multiple objects, a presentation value of the any object; and presenting the multiple objects according to presentation values of the multiple objects.

A computer readable storage medium is provided, where computer-readable instructions are stored in the computer readable storage medium, and the computer-readable instructions enable a computing device including one or more processors to execute the following functions when run on the computing device: acquiring multiple objects related to a search keyword of a user; acquiring a historical behavior object of the user; and determining a presentation order of the multiple objects based on similarity measures between the multiple objects and the historical behavior object of the user, where the similarity measures are determined based on basic behavior similarity measures between the multiple objects and the historical behavior object, and the basic behavior similarity measures between the multiple objects and the historical behavior object indicate that the user making a historical behavior for the historical behavior object makes similar behaviors for the multiple objects within a period of time.

In the search method described in the present disclosure, after multiple objects related to a keyword are found, presentation values of the objects are calculated by combining similarity measures between the objects and a historical behavior object of a user, and the objects are presented according to the presentation values of the objects. The similarity measures use the historical behavior object of the user as a reference, and the presentation values consider similarity degrees between to-be-presented objects and the historical behavior object of the user from multiple perspectives; therefore, a search result is more coincident with the behavior habit of the user.

### BRIEF DESCRIPTION OF THE DRAWINGS

To describe the technical solutions in the example embodiments of the present disclosure, the following briefly introduces the accompanying drawings describing the example embodiments. Apparently, the accompanying drawings described in the following merely represent some example embodiments described in the present disclosure, and those of ordinary skill in the art may still derive other drawings from these accompanying drawings without creative efforts.

FIG. 1 is a flowchart of a search method according to an example embodiment of the present disclosure;

FIG. 2 is a schematic diagram of a three-layer model according to an example embodiment of the present disclosure;

FIG. 3 is a flowchart of a training method for a three-layer model according to an example embodiment of the present disclosure;

FIG. 4(a) is a schematic diagram of historical search results of a user;

FIG. 4(b) is a schematic diagram of search results obtained by using an existing search method;

FIG. 4(c) is a schematic diagram of search results obtained by using a search method according to an example embodiment of the present disclosure; and

FIG. 5 is a schematic structural diagram of a search apparatus according to an example embodiment of the present disclosure.

### DETAILED DESCRIPTION

Search methods disclosed herein and in the example embodiments of the present disclosure may be applied to a server of a website (e.g., an e-commerce website). The server is configured to run the website. After a search engine of the website receives a search keyword, the server searches according to the keyword to obtain multiple related objects, and determines preferences of the user for various objects according to historical behavior data of the user. The objects are then presented in descending order of the preferences, thus improving the accuracy of search results for the user.

The technical solutions in the example embodiments of the present disclosure will be described clearly and completely through the accompanying drawings in the example embodiments of the present disclosure. Apparently, the described example embodiments are merely some example embodiments of the present disclosure, and are not all the example embodiments. Based on the example embodiments of the present disclosure, all other example embodiments derived by those of ordinary skill in the art without creative efforts shall fall within the protection scope of the present disclosure.

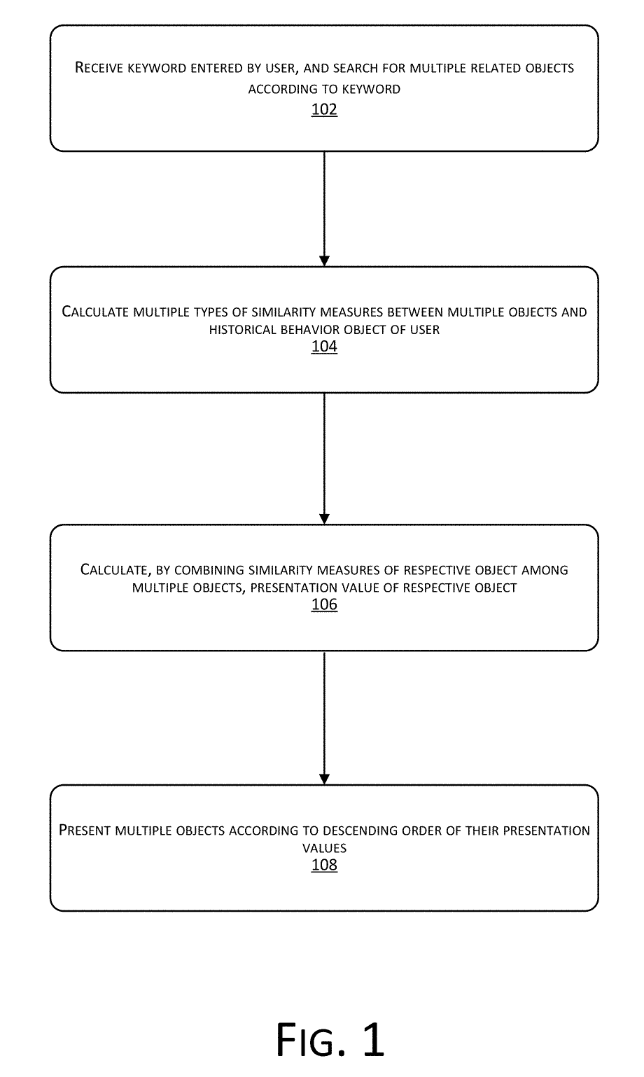

FIG. 1 shows a search method according to an example embodiment of the present disclosure, including the following steps.

S102: A keyword entered by a user is received, and multiple related objects are searched for according to the keyword.

The object is a target, and on a website, the target generally includes a target indicated by at least one of text, a numeral, a symbol, and a multimedia file such as an image or audio. For example, on an e-commerce website, the object is an item on the website, and the item is indicated by using a name and an image.

S104: Multiple similarity measures between the multiple objects and a historical behavior object of the user are calculated.

The historical behavior object is a target to which a historic behavior is applied. For example, on the e-commerce website, the historical behavior object may be an item added to favorites or an item purchased before.

The similarity measures are preferences of the user for the multiple objects reflected based on the historical behavior object of the user.

The multiple similarity measures at least include inter-object similarity measures, and optionally may further include, but not limited to, the following similarity measures: source similarity measures of objects and type similarity measures of objects. In this example embodiment, the inter-object similarity measure refers to a similarity degree between a found object and the historical behavior object. The source similarity measure of objects refers to a similarity degree between sources of a found object and the historical behavior object, and may be indicated by using a physical quantity, i.e., a source similarity score of the object. The type similarity measure of objects refers to a similarity degree between types of a found object and the historical behavior object, and may be indicated by using a physical quantity, i.e., a type similarity score of the object.

The inter-object similarity measures are determined according to basic behavior similarity measures between the multiple objects and the historical behavior object.

The user historical behavior data is as shown in formula (1):

Aᵢ={aₖ:k=1,2, . . . Kᵢ} (1)

where aₖ indicates a behavior of a user uᵢ, a behavior is a quadruple <nid, source type, time>, nid indicates an identifier of an object to which the behavior is applied, source indicates a source of the behavior (i.e., a scenario where the behavior occurs), type indicates a type of the behavior, and time indicates a time of the behavior. All Kᵢ behaviors of uᵢ are marked as a set Aᵢ.

Taking an e-commerce website as an example, nid indicates an ID of an item to which a behavior is applied; source includes, but is not limited to, search and Juhuasuan; type includes, but is not limited to, click, close a deal, additional purchase, and add to favorites; and time includes, but is not limited to, within one day.

The basic behavior similarity measures are indicated by using <item A, item B, bhv_typeA, bhv_typeB, time>, where item A denotes an item A, item B denotes an item B, bhv_typeA denotes a behavior of the user for the item A, bhv_typeB denotes a behavior of the same user for the item B, and time denotes a time when the behavior occurs. In other words, the basic behavior similarity measure is a behavior made for the item B by the user after making a behavior for the item A within a period of time. Specifically, the basic behavior similarity measure is indicated by using a physical quantity, i.e., the number of times similar behaviors are made for the item B within the period of time after the same user makes a behavior for the item A.

Specifically, as described above, the type of the behavior includes, but is not limited to, click, close a deal, additional purchase, and add to favorites; and time includes, but is not limited to, within one day.

For example, time is within 1 day, 3 days, 7 days, or 15 days. When the type of the behavior is click, close a deal, additional purchase, or add to favorites, 4*3*3=36 types of basic behavior similarity measures may be obtained.

The inter-object similarity measure refers to a similarity degree between basic behavior similarity measures, and may be indicated by using a physical quantity, i.e., an object similarity score. The specific manner of calculating the inter-object similarity measure by using the basic behavior similarity measure will be illustrated in the following example embodiment. Optionally, the inter-object similarity measure may further be determined according to an image similarity degree of objects and/or a difference between certain attributes of objects. For the e-commerce website, the inter-object similarity measure includes an image similarity degree between items and a price difference between the items.

By taking the e-commerce website as an example, the object similarity score is a similarity score between an item related to the keyword and an item of the user historical behavior. The source similarity score of objects is a similarity score between stores of the item related to the keyword and the item of the user historical behavior. The type similarity score of objects is a similarity score between brands of the item related to the keyword and the item of the user historical behavior.

Specific calculation processes of the similarity scores will be illustrated in the subsequent example embodiments.

S106: By combining similarity measures of a respective object among the multiple objects, a presentation value of the respective object is calculated.

S108: The multiple objects are presented according to a descending order of their presentation values.

The presentation value indicates a preference of the user entering the keyword for the object. Generally speaking, a higher presentation value indicates that the user is more in favor of the object.

It may be seen from the process shown in FIG. 1 that, in the search method described in this example embodiment, after objects related to a keyword are found, presentation values of the objects are calculated according to similarity measures between the objects and a historical behavior object of a user, and the objects are presented according to the presentation values of the objects. The similarity measures use the historical behavior object of the user as a reference, and the manner of calculating by combining multiple types of similarity measures considers similarity degrees between to-be-presented objects and the historical behavior object of the user from multiple perspectives; therefore, a search result is more coincident with the behavior habit of the user.

By taking the e-commerce website as an example, in S104, a process of calculating multiple types of similarity scores between any object (referred to as an item A in the following) among the objects related to the search keyword of the user and the historical behavior object (referred to as an item B in the following) of the user includes the following steps.

1. An object similarity score between the item A and the item B is acquired.

The object similarity score between the item A and the item B includes a general similarity score (indicating a general similarity measure) and a basic behavior similarity score. The general similarity score includes, but is not limited to, an image similarity degree and a price difference. The general similarity degree may be obtained using an existing manner, and details will not be described here. The object similarity score may be calculated by combining the general similarity score and the basic behavior similarity score, e.g., by adding the two similarity scores.

As described above, the basic behavior similarity score between the item A and the item B is obtained by counting the number of times behaviors (e.g., click, close a deal, additional purchase, and add to favorites) are made for the item B within a period of time (e.g., 1 day, 3 days, 7 days, and 15 days) after the user makes a behavior (e.g., click, close a deal, additional purchase, and add to favorites) for the item A.

2. The similarity score obtained in step 1 is multiplied by a preset behavior weight value to obtain an object similarity score, also referred to as an item to item (i2i) score.

During research, the applicant finds that a preference of the user for the item B is on one hand related to the similarity between the item A and the item B, and on the other hand related to a preference of the user for the item A. Therefore, a behavior weight is set in this example embodiment. That is, different weight values are used for behaviors having different time, different types and different sources when the object similarity score is calculated.

3. A store similarity score (a source score of objects) and a brand similarity score (a type similarity score of objects) are obtained separately based on step 1 and step 2. It should be noted that, a difference between calculation of the two similarity scores and the calculation of the object similarity score lies in different general similarity degrees used in step 1, general similarity degrees that need to be used for calculating the store score and the brand score may be set according to actual requirements, and details will not be described here. Reference may be made to the conventional techniques for the specific requirements and calculation methods, and details will not be described here.

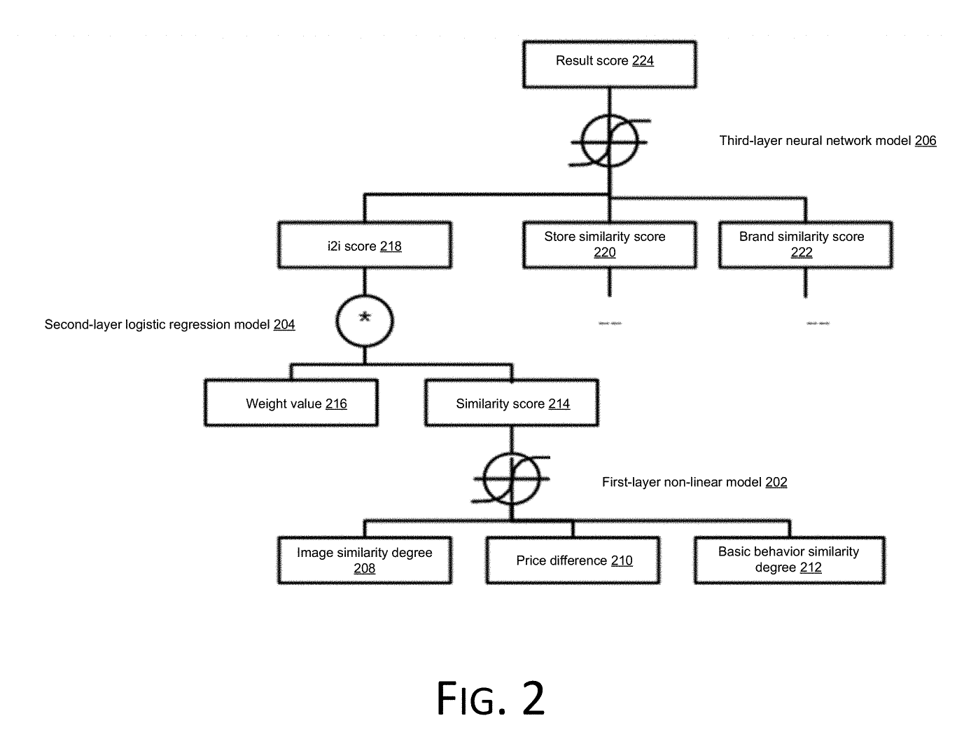

Optionally, with reference to the above process, S104 and S106 may be obtained by using an example model shown in FIG. 2.

The model as shown in FIG. 2 includes a three-layer structure, which includes a first-layer non-linear model, 202, a second-layer logistic regression model 204, and a third-layer neural network model 206. A function implemented by the first layer is acquiring the similarity score between the item A and the item B, including a image similarity degree 208, a price difference 210, and a basic behavior similarity score 212. The first layer may adopt a non-linear model, e.g., a gradient boosting decision tree (GBDT). A function implemented by the second layer is multiplying the similarity score 214 obtained in the first layer by a weight value 216, to obtain an i2i score 218. The second layer may adopt a logistic regression model. The second layer also obtains a store score 220 and a brand score 222. A function implemented by the third layer is merging multiple similarity scores including the i2i score 218, the store similarity score 220, and the brand similarity score 222 into a final result score 224. The third layer may adopt a neural network model.

In other words, a score of a found object may be obtained by inputting the object to the model trained based on A, as shown in FIG. 2.

It should be noted that, the model shown in FIG. 2 is merely an example implementation of S104 and S106, and the present disclosure is not limited to the model shown in FIG. 2.

A process of training the model shown in FIG. 2 will be described in detail by taking an e-commerce website as an example.

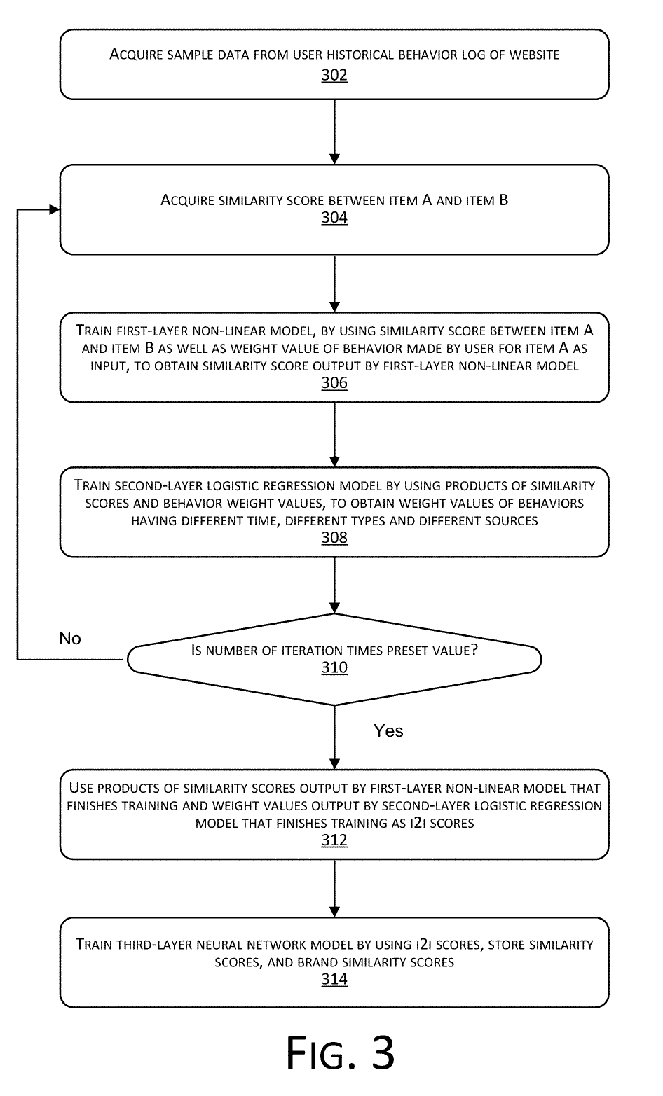

FIG. 3 is a training process of the three-layer model shown in FIG. 2, including the following steps.

S302: Sample data such as D={<Aᵢ,Iⱼ,y>} is acquired from a user historical behavior log of a website, such as a e-commerce website.

Each piece of data in D indicates whether the user u, makes a behavior for the item Iⱼ, indicated by y (for example, y is 1 if there is a behavior; otherwise, y is 0). The item Iⱼ and each item Iᵢ in the set Aᵢ form one item pair, indicating that the user makes a behavior (or makes no behavior) for the item Iⱼ after making a behavior for the item Iᵢ.

As the data is sample data, a value of each piece of data in D is known.

To facilitate description, Iᵢ is referred to as an item A and Iⱼ is referred to as an item B in the following.

S304: A similarity score between the item A and the item B is acquired or calculated.

S306: The similarity score between the item A and the item B, as well as a weight value of a behavior made by the user for the item A as input data of the first-layer non-linear model, and the first-layer non-linear model is trained according to the value of y, to obtain a similarity score output by the first-layer non-linear model.

Reference may be made to the conventional techniques for the specific training method, and details will not be described here.

Optionally, as it is difficult to accurately estimate similarity scores between items under different categories, to improve the preciseness of the first-layer nonlinear model and reduce the calculation volume, the input data of the first-layer non-linear model is similarity scores between items under the same category. In other words, similarity scores between the item A and the item B are used as the input data of the first-layer non-linear model to train the first-layer non-linear model only when they belong to the same category; otherwise, S302 and S306 are skipped.

When S306 is performed for the first time, weight values of behaviors having different time, different types and different sources are all initialized to 1.

S308: Products of the similarity scores and the behavior weight values are used as input data of the second-layer logistic regression model, and the second-layer logistic regression model is trained according to the value of y, to obtain weight values of the behaviors having different time, different types and different sources.

S310: whether the number of iteration times is a preset value is determined. S312 is performed if the number of iteration times is the preset value, and the process returns to S304 if the number of iteration times is not the preset value. When the process returns to step S304, the weight values newly obtained from the second-layer logistic regression model are used to calculate the basic behavior similarity scores in S304.

In other words, in this example embodiment, iterative training is performed on the first-layer non-linear model and the second-layer logistic regression model, such that the trained model has a better effect.

The iterative training is advantageous in avoiding distributing the behavior weights and the similarity scores into a non-linear model for training, thus avoiding the problem that actual storage and computing resources cannot support the training process.

S312: Products of the similarity scores output by the first-layer non-linear model that finishes the training and the weight values output by the second-layer logistic regression model that finishes the training are used as i2i scores, also referred to as object similarity scores.

S314: The i2i scores, the store similarity scores (the source similarity scores of objects), and the brand similarity scores (the type similarity scores of objects) are used as an input of the third-layer neural network model, and the third-layer neural network model is trained according to the value of y.

For example, the training the three-layer neural network model is, in essence, constructing a neural network structure in the following manner:

The training data is denoted as a triple <Uᵢ,Iⱼ,Iₖ>, indicating that the user Uᵢ makes a behavior for Iⱼ but does not make any behavior for Iₖ on a search result page. A collaborative score of Uᵢ for Iⱼ is f(Xⱼ), where f denotes a neural network, and Xⱼ denotes a vector of multiple single collaborative scores of the user for Iⱼ. In a Rank Net, an occurrence probability of each triple <Uᵢ,Iⱼ,Iₖ> is:

$${P}_{i , j , k} ≡ \frac{{e}^{{o}_{j , k}}}{1 + {e}^{{o}_{j , k}}}$$

where o_{j,k}=f(Xⱼ)−f(Xₖ). According to the definition of P, a neural network structure f may be obtained by learning based on a large number of samples, and therefore, multiple collaborative scores may be merged into a final score by using f.

So far, the training of the third-layer model is completed.

It should be noted that, the processes of acquiring the store score and the brand score are similar to the process of acquiring the i2i score, and the only difference lies in different general similarity scores calculated in S304, general similarity scores that need to be used for calculating the store score and the brand score may be set according to actual requirements, and details will not be described here. Reference may be made to the conventional techniques for the specific requirements and calculation methods, and details will not be described here.

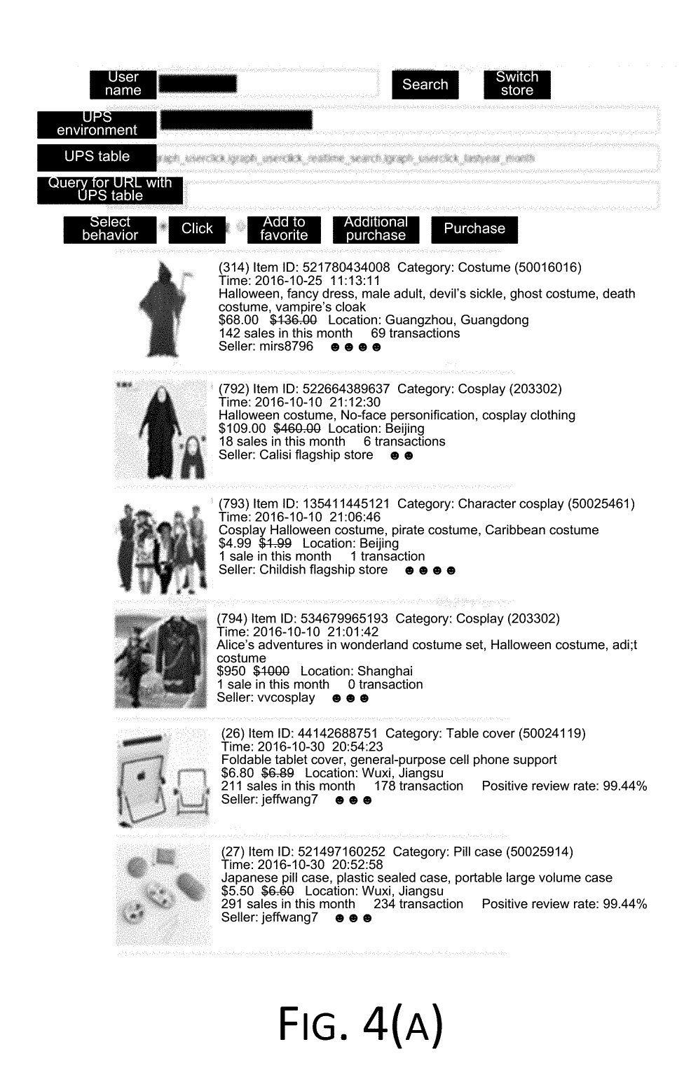

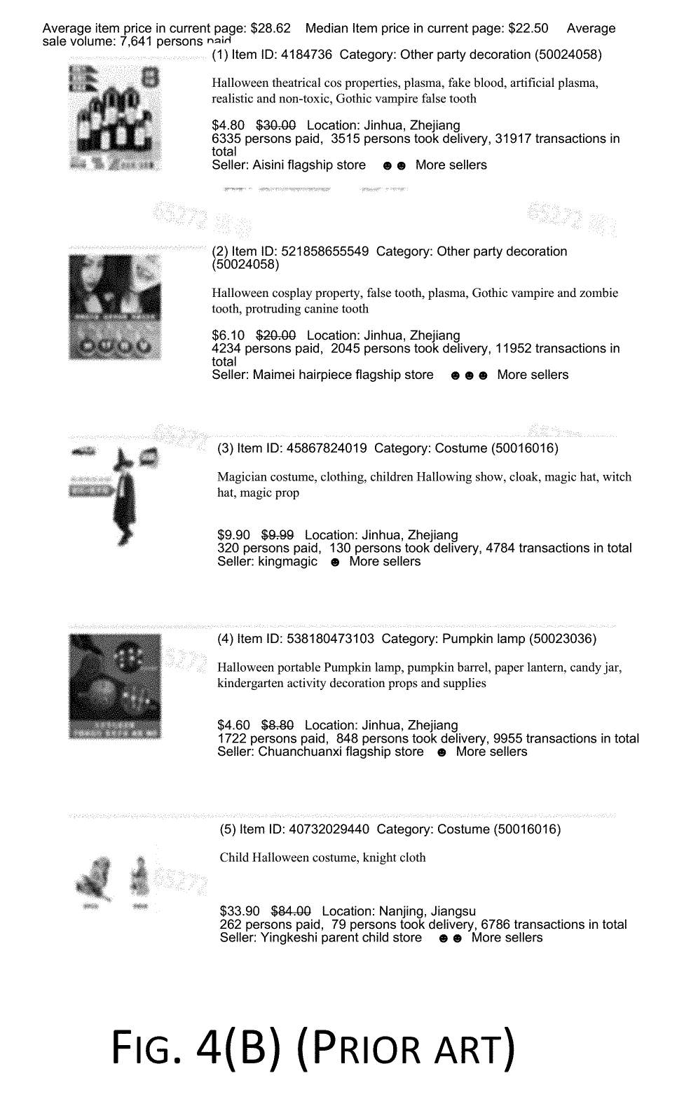

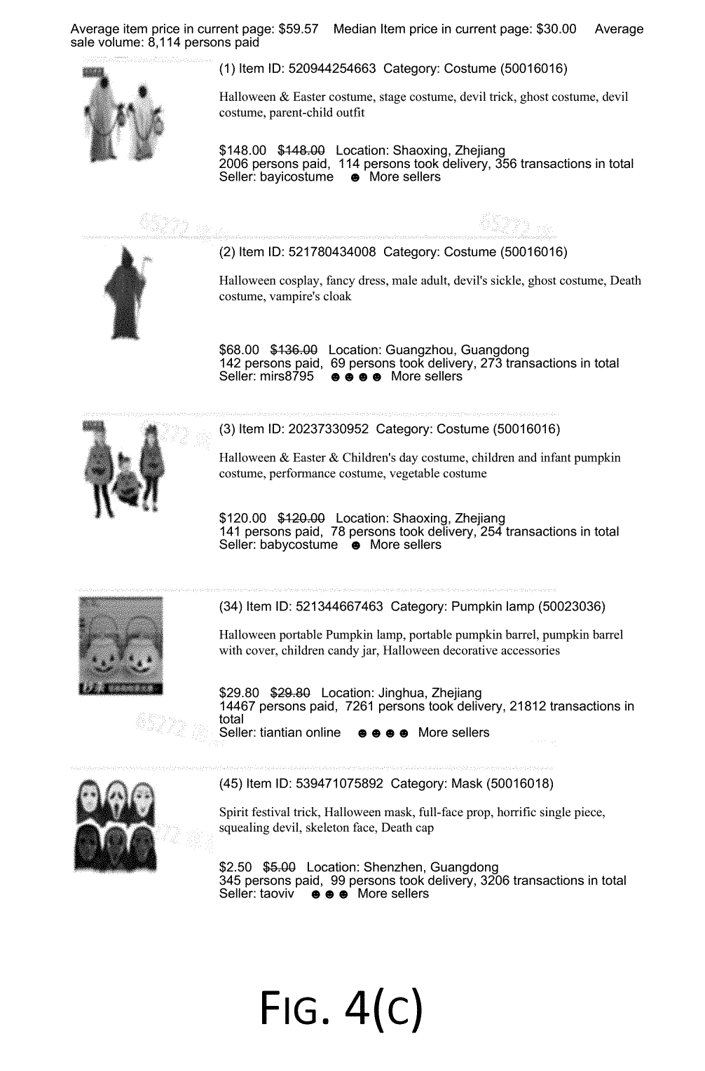

FIG. 4 schematically shows an effect of using the method shown in FIG. 1.

FIG. 4(a) is a shopping history of a user, including a list of user behaviors such as close a deal, click, and additional purchase. As shown from the behaviors of the user, the user mainly intends to purchase clothes for Halloween (the first four historical purchasing behaviors), and is in favor of simple clothes. FIG. 4(b) is a search result provided by an existing search method when the user enters “Halloween”. The user historical behaviors are not taken into consideration, and therefore, the displayed results are very diverging, including multiple categories such as “pumpkin lamp”, “false tooth”, “clothing”, and “broom”. The result is too diverging, and thus many displayed items in the displayed result are of low value, that is, most traffic is wasted by unwanted items.

FIG. 4(c) is a search result displayed by using the method shown in FIG. 1. Multiple types of similarity scores between items found by searching according to the keyword “Halloween” and the clothing for Halloween are calculated according to a user historical behavior: clothing for Halloween. The multiple types of similarity scores are merged into a score, and the items are sorted and presented according to the scores of the items, as shown in FIG. 4(c). FIG. 4(c) provides more presentation opportunities for items in strong relationships with the user historical behavior (in terms of similarity of items, similarity of stores, similarity of brands, and the like). Compared with FIG. 4(b), it may be seen that the presented results have more clothing related to the Halloween, and therefore, in consideration of the actual requirement of the user, the value of traffic for presenting this part will be much higher than the value of traffic for presenting other items. With reference to the user historical behavior in FIG. 4(a), it may be seen that the presented clothing is strongly similar to the item of the user behavior.

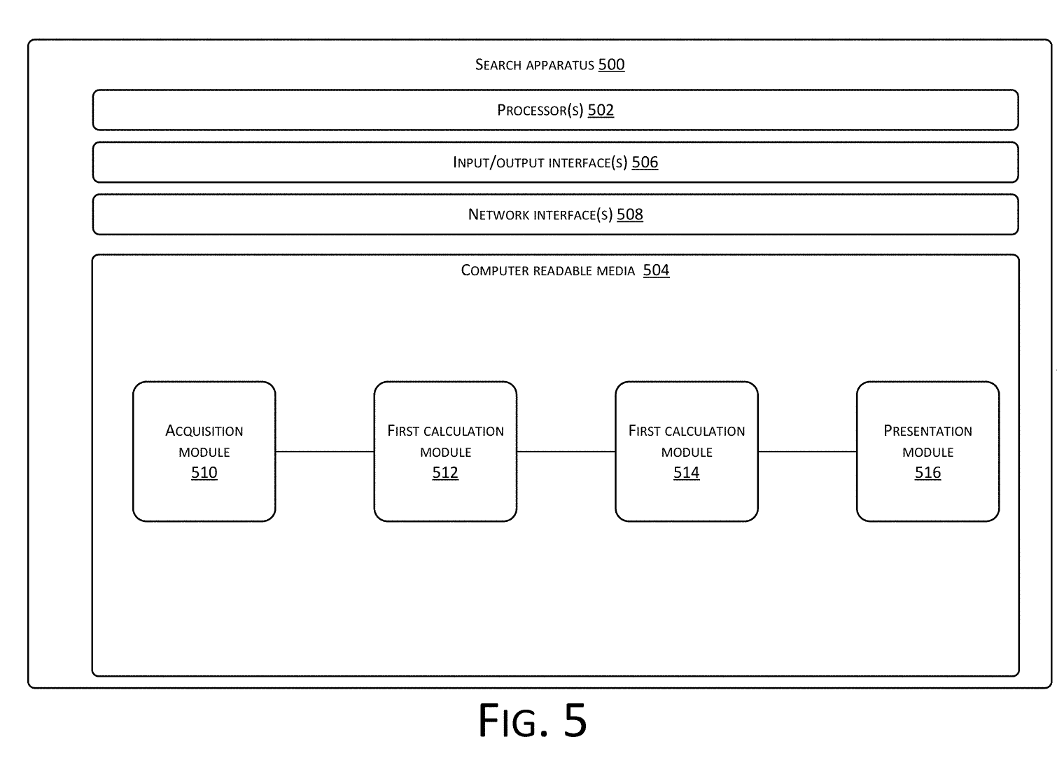

FIG. 5 shows a search apparatus disclosed in an example embodiment of the present disclosure. As shown in FIG. 5, a search apparatus 500 includes one or more processor(s) 502 or data processing unit(s) and memory 504. The apparatus 500 may further include one or more input/output interface(s) 506 and one or more network interface(s) 508. The memory 504 is an example of computer readable media.

Computer readable media, including both permanent and non-permanent, removable and non-removable media, may be stored by any method or technology for storage of information. The information can be computer readable instructions, data structures, modules of programs, or other data. Examples of computer storage media include, but are not limited to, phase change memory (PRAM), static random access memory (SRAM), dynamic random access memory (DRAM), other types of random access memory (RAM), read only memory Such as ROM, EEPROM, flash memory or other memory technology, CD-ROM, DVD, or other optical storage, Magnetic cassettes, magnetic tape magnetic tape storage or other magnetic storage devices, or any other non-transitory medium, may be used to store information that may be accessed by a computing device. As defined herein, computer-readable media do not include non-transitory transitory media such as modulated data signals and carriers.

The memory 504 may store therein a plurality of modules or units including an acquisition module 510, a first calculation module 512, a second calculation module 514, and a presentation module 516.

The acquisition module 510 is configured to acquire multiple objects related to a search keyword of a user. The first calculation module 512 is configured to determine similarity measures between the objects and a historical behavior object of the user. The second calculation module 514 is configured to calculate, by combining similarity measures of any object among the multiple objects, a presentation value of the any object. The presentation module 516 is configured to present the multiple objects according to presentation values of the multiple objects.

Reference may be made to the method example embodiment for specific implementations of functions of the above modules, and details will not be described here.

The search apparatus shown in FIG. 5 may be applied to a server of a website to improve the accuracy of a search result for the user.

An example embodiment of the present disclosure further discloses a computer readable storage medium. The computer readable storage medium stores instructions, and the instructions, when run on a computer, enable the computer to perform the process described in the method example embodiment.

The function described in the method according to the example embodiments of the present disclosure may be stored in a computer readable medium when it is implemented in the form of a software functional unit and sold or used as an independent product. Based on such an understanding, the part of the example embodiment of the present disclosure contributing to the conventional techniques, or a part of the technical solution may be implemented in the form of a software product. The software product may be stored in the computer readable medium, and includes computer-readable instructions for instructing a computing device (which may be a personal computer, a server, a mobile computing device, a network device, or the like) to execute all or some of steps in the methods described in the example embodiments of the present disclosure. The computer readable medium includes: a USB flash drive, a mobile hard disk, a Read-Only Memory (ROM), a Random Access Memory (RAM), a magnetic disk, an optical disc, or other mediums that may store program codes.

The example embodiments of this specification are all described in a progressive manner, each example embodiment emphasizes a difference between it and other example embodiments, and identical or similar parts in the example embodiments may be obtained with reference to each other.

The above descriptions of the disclosed example embodiments enable those skilled in the art to implement or use the present disclosure. Various modifications on the example embodiments are obvious for those skilled in the art, and general principles defined in this text may be implemented in other example embodiments without departing from the spirit or scope of the present disclosure. Therefore, the present disclosure is not limited by the example embodiments shown in this text, but conforms to the widest range consistent with the principle and innovative features disclosed in this text.

The present disclosure may further be understood with clauses as follows

Clause 1. A search method, comprising:

acquiring multiple objects related to a search keyword of a user;

calculating similarity measures between the multiple objects and a historical behavior object of the user, wherein the similarity measures at least comprise inter-object similarity measures, the inter-object similarity measures are determined at least based on basic behavior similarity measures between the multiple objects and the historical behavior object, and the basic behavior similarity measures between the multiple objects and the historical behavior object indicate that the user making a historical behavior for the historical behavior object makes similar behaviors for the multiple objects within a period of time;

calculating, by combining similarity measures of any object among the multiple objects, a presentation value of the any object; and

presenting the multiple objects according to presentation values of the multiple objects.

Clause 2. The method of clause 1, wherein the similarity measures further comprise:

source similarity measures of objects and/or type similarity measures of objects,

wherein the source similarity measures of the multiple objects are used for indicating similarity degrees between sources of the multiple objects and a source of the historical behavior object; and

the type similarity measures of the multiple objects are used for indicating similarity degrees between types of the multiple objects and a type of the historical behavior object.

Clause 3. The method of clause 1 or 2, wherein the inter-object similarity measures are further determined based on general similarity measures between the multiple objects and the historical behavior object, wherein the general similarity measures between the multiple objects and the historical behavior object comprise image similarity degrees between the multiple objects and the historical behavior object and/or differences between attributes of the multiple objects and the historical behavior object.

Clause 4. The method of clause 1, wherein the process of determining an inter-object similarity measure between any object among the multiple objects and the historical behavior object comprises:

calculating an inter-object similarity measure between the object and any historical behavior object of the user; and

multiplying the inter-object similarity measure by a weight value of the historical behavior of the user to obtain the inter-object similarity measure between the object and the historical behavior object.

Clause 5. A search method, comprising:

acquiring multiple objects related to a search keyword of a user;

acquiring a historical behavior object of the user; and

determining a presentation order of the multiple objects based on similarity measures between the multiple objects and the historical behavior object of the user,

wherein the similarity measures are determined based on basic behavior similarity measures between the multiple objects and the historical behavior object, and the basic behavior similarity measures between the multiple objects and the historical behavior object indicate that the user making a historical behavior for the historical behavior object makes similar behaviors for the multiple objects within a period of time.

Clause 6. The method of clause 5, wherein the process of determining a similarity measure between any object among the multiple objects and the historical behavior object comprises:

calculating a basic behavior similarity measure between the object and any historical behavior object of the user; and

multiplying the basic behavior similarity measure by a weight value of the historical behavior of the user to obtain the inter-object similarity measure between the object and the historical behavior object.

Clause 7. A search apparatus, comprising:

an acquisition module configured to acquire multiple objects related to a search keyword of a user;

a first calculation module configured to calculate similarity measures between the multiple objects and a historical behavior object of the user, wherein the similarity measures at least comprise inter-object similarity measures, the inter-object similarity measures are determined at least based on basic behavior similarity measures between the multiple objects and the historical behavior object, and the basic behavior similarity measures between the multiple objects and the historical behavior object indicate that the user making a historical behavior for the historical behavior object makes similar behaviors for the multiple objects within a period of time;

a second calculation module configured to calculate, by combining similarity measures of any object among the multiple objects, a presentation value of the any object; and

a presentation module configured to present the multiple objects according to presentation values of the multiple objects.

Clause 8. The apparatus according to clause 7, wherein the first calculation module is configured to:

calculate source similarity measures between the objects and the historical behavior object of the user and/or type similarity measures of objects, wherein the source similarity measures of the multiple objects are used for indicating similarity degrees between sources of the multiple objects and a source of the historical behavior object; and the type similarity measures of the multiple objects are used for indicating similarity degrees between types of the multiple objects and a type of the historical behavior object.

Clause 9. The apparatus according to clause 7 or 8, wherein the first calculation module is configured to:

further determine the inter-object similarity measures based on general similarity measures between the multiple objects and the historical behavior object, wherein the general similarity measures between the multiple objects and the historical behavior object comprise image similarity degrees between the multiple objects and the historical behavior object and/or differences between attributes of the multiple objects and the historical behavior object.

Clause 10. The apparatus according to clause 7, wherein the first calculation module is configured to:

calculate an inter-object similarity measure between the object and any historical behavior object of the user; and multiply the inter-object similarity measure by a weight value of the historical behavior of the user to obtain the inter-object similarity measure between the object and the historical behavior object.

Clause 11. A computer readable storage medium, wherein instructions are stored in the computer readable storage medium, and the instructions enable a computer to execute the following functions when run on the computer: acquiring multiple objects related to a search keyword of a user; calculating similarity measures between the multiple objects and a historical behavior object of the user, wherein the similarity measures at least comprise inter-object similarity measures, the inter-object similarity measures are determined at least based on basic behavior similarity measures between the multiple objects and the historical behavior object, and the basic behavior similarity measures between the multiple objects and the historical behavior object indicate that the user making a historical behavior for the historical behavior object makes similar behaviors for the multiple objects within a period of time; calculating, by combining similarity measures of any object among the multiple objects, a presentation value of the any object; and presenting the multiple objects according to presentation values of the multiple objects.

Clause 12. A computer readable storage medium, wherein instructions are stored in the computer readable storage medium, and the instructions enable a computer to execute the following functions when run on the computer: acquiring multiple objects related to a search keyword of a user; acquiring a historical behavior object of the user; and determining a presentation order of the multiple objects based on similarity measures between the multiple objects and the historical behavior object of the user, wherein the similarity measures are determined based on basic behavior similarity measures between the multiple objects and the historical behavior object, and the basic behavior similarity measures between the multiple objects and the historical behavior object indicate that the user making a historical behavior for the historical behavior object makes similar behaviors for the multiple objects within a period of time.

What is claimed is:

1. A method comprising:
acquiring multiple objects related to a search keyword of a user;
calculating similarity measures between the multiple objects and a historical behavior object of the user;
calculating, by combining respective similarity measures of a respective object among the multiple objects, a presentation value of the respective object; and
presenting the multiple objects according to respective presentation values of the multiple objects.

2. The method of claim 1, wherein the similarity measures at least include inter-object similarity measures.

3. The method of claim 2, further comprising determining the inter-object similarity measures at least based on basic behavior similarity measures between the multiple objects and the historical behavior object.

4. The method of claim 3, wherein the basic behavior similarity measures between the multiple objects and the historical behavior object indicate that the user conducting a historical behavior for the historical behavior object conducts similar behaviors for the multiple objects within a preset period of time.

5. The method of clause 4, wherein the similarity measures further include source similarity measures of objects.

6. The method of claim 5, wherein the source similarity measures of the multiple objects indicate similarity degrees between sources of the multiple objects and a source of the historical behavior object.

7. The method of clause 4, wherein the similarity measures further include type similarity measures of objects.

8. The method of claim 7, wherein the type similarity measures of the multiple objects indicate similarity degrees between types of the multiple objects and a type of the historical behavior object.

9. The method of claim 4, wherein the determining the inter-object similarity measures include:
determining the inter-object similarity measures based on general similarity measures between the multiple objects and the historical behavior object.

10. The method of claim 9, wherein the general similarity measures between the multiple objects and the historical behavior object include image similarity degrees between the multiple objects and the historical behavior object.

11. The method of claim 9, wherein the general similarity measures between the multiple objects and the historical behavior object include differences between attributes of the multiple objects and the historical behavior object.

12. The method of claim 4, wherein the calculating the similarity measures between the multiple objects and the historical behavior object of the user include:
calculating an inter-object similarity measure between the respective object and the historical behavior object of the user; and
multiplying the inter-object similarity measure by a weight value of the historical behavior of the user to obtain the inter-object similarity measure between the respective object and the historical behavior object.

13. A method comprising:
acquiring multiple objects related to a search keyword of a user;
acquiring a historical behavior object of the user; and
determining a presentation order of the multiple objects based on similarity measures between the multiple objects and the historical behavior object of the user respectively.

14. The method of claim 13, further comprising determining the similarity measures based on basic behavior similarity measures between the multiple objects and the historical behavior object respectively.

15. The method of claim 14, wherein the basic behavior similarity measures between the multiple objects and the historical behavior object indicate that the user conducting a historical behavior for the historical behavior object conducts similar behaviors for the multiple objects within a preset period of time.

16. The method of claim 14, wherein the determining the similarity measures based on basic behavior similarity measures between the multiple objects and the historical behavior object respectively includes:
calculating a basic behavior similarity measure between a respective object and the historical behavior object of the user; and
multiplying the basic behavior similarity measure by a weight value of the historical behavior of the user to obtain an inter-object similarity measure between the respective object and the historical behavior object.

17. An apparatus comprising:
one or more processors; and
one or more memories storing thereon computer-readable instructions that, when executed by the one or more processors, cause the one or more processors to perform acts comprising:
acquiring multiple objects related to a search keyword of a user;
calculating similarity measures between the multiple objects and a historical behavior object of the user, wherein the similarity measures at least include inter-object similarity measures, the inter-object similarity measures are determined at least based on basic behavior similarity measures between the multiple objects and the historical behavior object, and the basic behavior similarity measures between the multiple objects and the historical behavior object indicate that the user conducting a historical behavior for the historical behavior object conducts similar behaviors for the multiple objects within a period of time;
calculating, by combining similarity measures of a respective object among the multiple objects, a presentation value of the respective object; and
presenting the multiple objects according to respective presentation values of the multiple objects.

18. The apparatus of claim 17, wherein the calculating the similarity measures between the multiple objects and the historical behavior object of the user include:
calculating source similarity measures between the multiple objects and the historical behavior object of the user and type similarity measures of the multiple objects,
wherein:
the source similarity measures of the multiple objects indicate similarity degrees between sources of the multiple objects and a source of the historical behavior object; and
the type similarity measures of the multiple objects indicate similarity degrees between types of the multiple objects and a type of the historical behavior object.

19. The apparatus of claim 17, wherein the acts further comprise:
determining inter-object similarity measures based on general similarity measures between the multiple objects and the historical behavior object,
wherein the general similarity measures between the multiple objects and the historical behavior object include:
image similarity degrees between the multiple objects and the historical behavior object; and
differences between attributes of the multiple objects and the historical behavior object.

20. The apparatus of claim 17, wherein the acts further comprise:
calculating an inter-object similarity measure between the respective object and the historical behavior object of the user; and
multiplying the inter-object similarity measure by a weight value of the historical behavior of the user to obtain the inter-object similarity measure between the respective object and the historical behavior object.
